(19) United States
(12) Patent Application Publication
(10) Pub. No.: US 2025/0113932 A1
(43) Pub. Date: Apr. 10, 2025

(54) FLOOR MAT HANGER

(71) Applicant: Custom Accessories Inc., Richmond, IL (US)

(72) Inventors: Vincent Alesi, Richmond, IL (US); Anthony Ferenzi, Richmond, IL (US)

(73) Assignee: Custom Accessories Inc., Richmond, IL (US)

(21) Appl. No.: 18/941,582

(22) Filed: Nov. 8, 2024

Related U.S. Application Data
(60) Provisional application No. 63/542,669, filed on Oct. 5, 2023.

(51) Int. Cl. A47F 7/16

(52) U.S. Cl. CPC A47F 7/16

(57) ABSTRACT

A floor mat hanger includes a frame, a pair of pins passing through a corresponding pair of holes in the frame and supporting a middle member. The middle member, disposed between a front member and a back member of the frame, may rotate about one of the pins and releasably fasten to the other pin. A protrusion on the middle member limits the amount of rotation by being stopped by a crosspiece of the frame. The middle member and a hook/handle member includes a hook and a handle are rotatably connected.

### CROSS-REFERENCE TO RELATED APPLICATIONS

The instant application claims the benefit of U.S. Provisional Patent Application No. 63/542,669, filed Oct. 5, 2023, which is incorporated herein in its entirety by reference. The instant application is also related to U.S. Design application Ser. No. 29/930,849, filed Mar. 4, 2024, the contents of which are incorporated herein in their entirety by reference.

### FIELD OF THE DISCLOSURE

The present disclosure generally relates to retail display devices for merchandise and, more particularly, to an automotive floor mat hanger.

### BACKGROUND

Items, for example, merchandise, may be displayed by hanging the items from rods, pegs, and the like. Items may be hung directly from a rod, peg, or the like (hereinafter referred to generally as a rod), or the items themselves may be placed on hangers that hang from a rod. Merchandise, for example, floor mats for a car, a truck, or other types of vehicles, may need to be warehoused, transported to stores or shipped directly to customers in the case of online sales, and placed on display. A hanger that more effectively meets one or more of these needs is desirable.

### BRIEF SUMMARY

One aspect of the present disclosure describes a hanger for floor mats. The hanger includes a frame, a left pin, a right pin, a middle member, a hook/handle member, and at least a left crosspiece and a right crosspiece. The frame includes a front member and a back member. The front member includes a front wall having an essentially flat front surface that extends farther horizontally than vertically; a left front hole through the front wall; and a right front hole through the front wall disposed essentially symmetrically in the horizontal direction and the vertical direction with the left front hole. The back member includes a back wall having an essentially flat back surface that extends horizontally and vertically to match the front wall, the back wall being essentially parallel to the front wall; a left back hole through the back wall aligned in the front-back direction with the left front hole; and a right back hole through the back wall aligned in the front-back direction with the right front hole. Each crosspiece is fixed to both a top surface of the front member and a top surface of the back member. The left pin is inserted through the left front hole and the left back hole and the right pin inserted through the right front hole and the right back hole. The middle member includes a right middle hole aligned with the right front hole and the right back hole and receiving the right pin and rotatable around the right pin in a plane essentially perpendicular to the right pin; an upward opening aligned with the left front hole and the left back hole and configured to snap fit over the left pin; a protrusion from a right end of the middle member that limits rotation of the middle member around the right pin; and a vertical hole running through the middle member from top to bottom. The hook/handle member includes: a rod-like portion rotatably disposed through the vertical hole; a hook opening downward; and a handle, where the middle member and the hook/handle member are configured to rotate as a unit down into the frame.

### BRIEF DESCRIPTION OF THE DRAWINGS

FIG. 1 depicts a floor mat hanger with a floor mat in accordance with the disclosure.

FIG. 2A depicts a cut-away perspective view of a floor mat hanger in accordance with the disclosure.

FIG. 2B depicts a perspective view of a floor mat hanger in accordance with the disclosure.

FIG. 3 depicts a partial view of a floor mat hanger with a cover in accordance with the disclosure.

FIGS. 4A-4E depict different types of fasteners in accordance with the disclosure.

FIGS. 5A and 5B depict a cross sectional view and an end view, respectively, of an end cap in accordance with the disclosure.

### DETAILED DESCRIPTION

Hangers may be used to hang a variety of items. In the present disclosure, floor mats will generally be used as an example of such an item. However, the disclosure and the invention disclosed are not limited to floor mats unless otherwise indicated. Further, floor mat (singular) and floor mats (plural) may be used interchangeably unless otherwise specified because floor mat hangers may be used to hang a single floor mat or a plurality of floor mats.

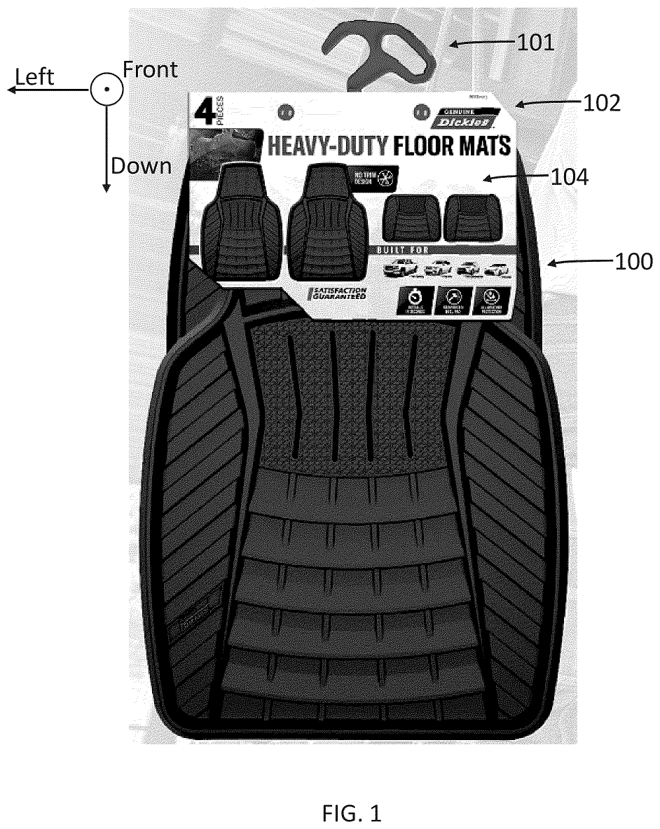

Referring to FIG. 1, a floor mat 100 is depicted hanging from a floor mat hanger 102. The floor mat hanger 102 as shown here extends at least in part above the top of the floor mat 100. Coordinate axes are provided in many of the figures to distinguish up from down, left from right, and front from back. These three pairs of directions are mutually orthogonal.

Still referring to FIG. 1, a cover 104 may also hang from the floor mat hanger 102 and over at least a portion of the floor mat 100. The cover 104 may be constructed of a paper and/or plastic product. The cover 104 may include printed matter related the floor mat 100 such as vehicle suitability, installation instructions, care instructions, and figures or images of the floor mat 100. The printed matter shown on the cover 104 in FIG. 1 and other figures is exemplary and non-limiting, including as to the type and number of product on the hanger 102. As will be seen in greater detail below, the cover 104 may include three sides, for example, a front, a top, and a back. In other aspects of the disclosure, the cover 104 may have more or less than three sides.

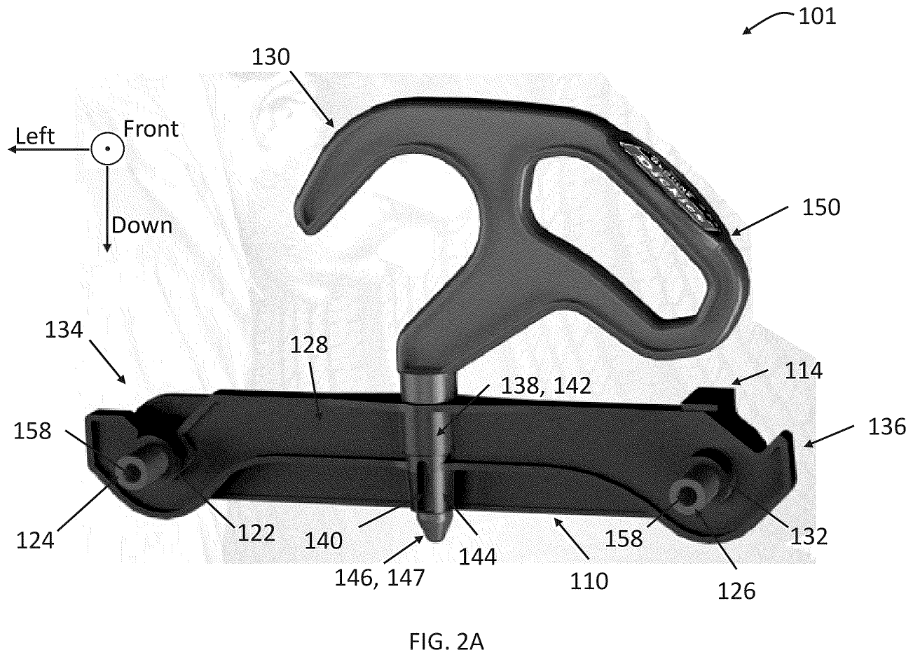

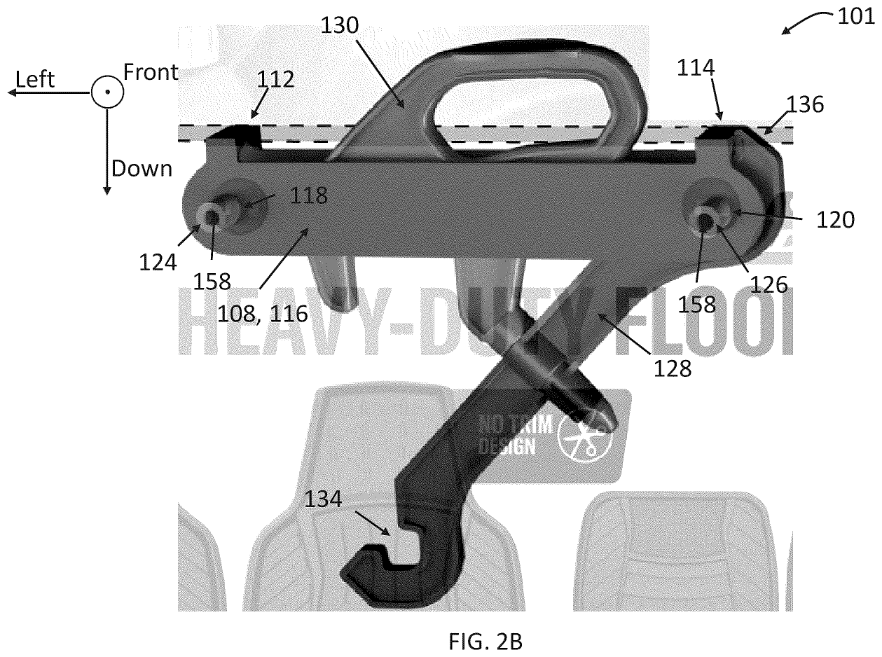

Two views of a floor mat hanger 102 are shown in FIGS. 2A and 2B. As shown in these two figures, the floor mat hanger 102 may include a frame 106, a left pin 124, a right pin 126, a middle member 128, and a hook/handle member 130. The floor mat hanger 102 or any of its constituent parts may include metal and/or plastic.

The frame 106 may include a front member 108, a back member 110, a left crosspiece 112, and a right crosspiece 114. The frame may be formed as a single piece.

Referring to FIG. 2B, the front member 108 may have a front wall 116. The front wall 116, in one or more aspects, may be essentially flat. In other aspects, the front wall 116 may be textured or include other features. The front wall 116 that faces front may extend farther horizontally (that is, in the left-right direction) than vertically (that is, in the up-down direction). The front member 108 may include a left front hole 118 and a right front hole 120 through the front wall 116. The right front hole 120 may be disposed essentially symmetrically in the horizontal direction and the vertical direction with the left front hole 118. The corners of the front wall 116 may be rounded.

The back member 110 may include a back wall (facing back into the page in FIG. 2A). The back wall may have a back surface that is essentially flat. In one or more aspects, the back surface may include texture or other features. The back wall may extend horizontally and vertically to match the front wall 116. The corners of the back wall may be rounded. The back wall may be essentially parallel to the front wall 116. Back member 110 may include a left back hole 122 through the back wall. The left back hole 122 may be aligned in the front-back direction with the left front hole 118. The back member 110 may also include a right back hole (not shown, but with similarities to the left back hole 122). The right back hole may be aligned in the front-back direction with the right front hole 120.

The left crosspiece 112 and the right crosspiece 114 may each be fixed to both a top surface of the front member 108 and a top surface of the back member 110. The crosspieces 112, 114 may be fixed by screws, by adhesive, by fusing with heat, by welding, by creating the frame 106 as a single molded piece, or by similar means.

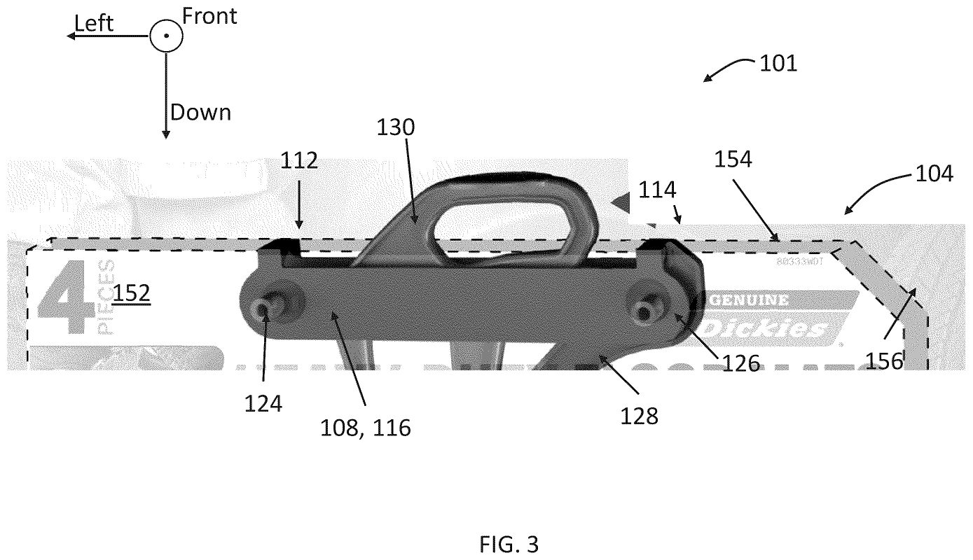

The floor mat hanger may also include a left pin 124 and a right pin 126. The left pin 124 may be inserted through the left front hole 118 and the left back hole 122. The right pin 126 may be inserted through the right front hole 120 and the right back hole. The left pin 124 and the right pin 126 may be configured to support at least one floor mat 100. As seen in FIG. 3, the left pin 124 and the right pin 126 may extend in front of the front wall 116. Some or all floor mats 100 may hang from the portion of the pins 124, 126 that extend in front of the wall 116. Further, some or all of the floor mats 100 may hang from the portion of the pins 124, 126 between the front member 108 and the back member 110. In one or more aspects, at least one end of at least one pin of the left pin 124 or the right pin 126 may include a hollow center 158 configured to mate with the respective end cap, discussed below.

The middle member 128 of the floor mat hanger 102 may be disposed between the front member 108 and the back member 110. The middle member 128 may include a right middle hole 132. The right middle hole 132 may be aligned with the right front hole 120 and the right back hole. The middle member 128 may also include an upward opening 134 aligned with the left front hole 118 and the left back hole 122. The upward opening may be configured to snap fit over the left pin 124. A snap fit may be implemented with plastic, although other materials may also be used. A snap fit allows one or more interacting parts to elastically deform from and then return to an original shape. In a snap fit process, the interacting parts become fastened in a way that requires energy to be expended to then separate the parts. The snap fit may be such that a force greater than a force of the one or more floor mats 100 supported by the floor mat hanger 102 is required to open the snap fit.

In one or more aspects, the left front hole 118, the left back hole 122, the right front hole 120, the right back hole, the left pin 124, and the right pin 126 are each circular in cross section.

In one or more aspects, an inner diameter of the left front hole 118, an inner diameter of the left back hole 122, and an outer diameter of the left pin 124 are essentially equal. In one or more aspects, an inner diameter of the right front hole 120, an inner diameter of the right back hole, an inner diameter of the right middle hole 132, and the outer diameter of the right pin 126 are essentially equal.

The frame 106 may include a space between a back side of the front wall 116 and a front side of the back wall sufficient for the middle member 128 and at least a portion of the hook/handle member 130 to rotate about the right pin 126 and through the space.

The middle member 128 may further include a protrusion 136 from a right end of the middle member 128 that limits rotation of the middle member 128 around the right pin 126. The rotation of the middle member is limited by the protrusion 136 encountering the right crosspiece 114. The protrusion 136 and the right crosspiece 114 may limit rotation of the middle member 128 with respect to the frame 106 in the counterclockwise direction when viewed from the front. Rotation of the middle member 128 with respect to the frame 106 may be limited in the clockwise direction by the snap fitting of the upward opening 134 over the left pin 124.

The middle member 128 may also include a vertical hole 138 running through the middle member 128 from top to bottom. In one or more aspects of the disclosure, the vertical hole 138 may include a slot 140 extending upward from the bottom end of the vertical hole 138 to allow the slotted portion of the vertical hole 138 to elastically deform to create a snap fit to be further described below. In one or more aspects, the vertical hole 138 may have a larger inner diameter in a top section 142 and smaller inner diameter in a bottom section 144. The slot 140 may be not extend beyond the bottom section 144, while in other aspects of the disclosure, the slot 140 may extend into the top section 142.

The hook/handle member 130 of the floor mat hanger 102 may include a rod-like portion 146 rotatably disposed through the vertical hole 138. The rod-like portion 146 may pass through the vertical hole 138 from top to bottom.

Having passed through the vertical hole 138, the rod-like portion 146 may be secured from removal from the vertical hole 138 while being free to rotate in the vertical hole 138. In one or more aspects, a free end 147 of the rod-like portion 146 may be configured to snap fit with the slotted portion of the vertical hole 138. That is, the slotted portion of the vertical hole 138 increases in inner diameter because of the slot 140 as the free end 147 of the rod-like portion 146 pass through and returns to an original inner diameter afterward, fixing the rod-like portion 146 in the vertical hole 138. In one or more aspects, the free end 147 of the rod-like portion 146 may include shaped conically tip with a maximum outer diameter greater than the original (un-deformed) inner diameter of the slotted section of the vertical hole 138. That is, the vertical hole 138 may include a bottom section 144 that includes a slot 140 that allows the bottom section 144 to broaden temporarily while the conically-shaped tip passes through, forming a snap fit.

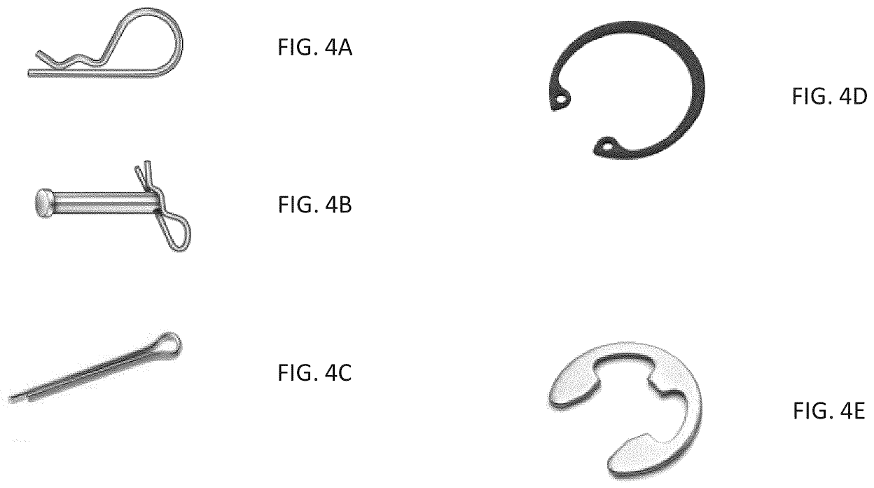

In one or more aspects, the rod-like portion 146 may be rotatably secured (or fixed) in the vertical hole 138 by use of at least one of a snap fit (as discussed above), a cotter pin, a C-clip retaining clip, an E-clip retaining clip, and the like. By rotatably secured, it is understood that the rod-like portion 146 is secured in the vertical hole 138 as well as free to rotate in the vertical hole 138. FIGS. 4A-4C present three examples of cotter pins. Cotter pins would require a corresponding hole through the rod-like portion 146 near the free end 147 that extends beyond the bottom of the vertical hole 138. FIGS. 4D and 4E present examples of a C-clip and an E-clip, respectively. These clips would require a corresponding groove around the circumference of part the rod-like portion 146 that extends beyond the bottom of the vertical hole 138.

The hook/handle member 130 may include a hook 148 that opens downward. In this instance, the hook 148 opening downward is to be understood as sufficiently downward for the hook 148 to be placed over a rod, a peg, or the like, and remain, along with the rest of the floor mat hanger 102 in a hanging position. The hook 148 may be angled downward at an angle greater than 0° and less than 180° when measured with respect to the horizontal (that is, the plane defined by the left-axis and the front axis). For example, the angle of the opening of the hook 148 may be downward between 30° and 60°, inclusively, with the horizontal direction, for example, essentially 45°.

The hook/handle member 130 may also include a handle 150. The handle 150 may be closed hole. The handle 150 may include contoured surfaces for ease of gripping. The handle 150 may be elongated and also may not be regular geometric shape, such as a square, a rectangle, a circle, an ellipse, and the like. The elongated orientation of the handle 150 may be 0° and 90° with the horizontal plane. For example, the handle 150 may be oriented between 30° and 60°, even 45°.

Referring to FIGS. 2B and 3, the middle member 128 and the hook/handle member 130 may be configured to rotate as a unit down into the frame 106, between the front member 108 and the back member 110. The rotation may be about the right pin 126.

Still referring to FIG. 3, the cover 104 of the floor mat hanger 102 may be three-sided, although a cover with fewer or more sides may be used. As shown in this non-limiting example, the cover 104 may include a front cover portion 150, a top cover portion 152, and/or a back cover portion 154. The portions of the cover 104 may be formed from a single piece of material such as paper, cardboard, plastic, or the like. Alternatively, the portions of the cover 104 may be formed separately and joined at adjacent edges. The cover 104 may be suspended, via the top cover portion 152, by the left crosspiece 112 and/or the right crosspiece 114 of the frame 106. In one or more aspects, the front cover portion 150 and/or the back cover portion 154 may include a hole or holes for one or both of the left pin 124 and the right pin 126 to pass through.

In one or more aspects, the left crosspiece 112 may be disposed above the left pin 124. Similarly, the right crosspiece 114 may be disposed above the right pin 126.

The left pin 114 and/or the right pin 126 may each receive a front end cap and/or a back end cap. These end caps 160 may be used to secure the cover 104 to the other parts of the floor mat hanger 102. The one or more front end caps 160 may be used to secure the front cover portion 152. Similarly, the one or more back end caps 160 may be used to secure the back cover portion 156.

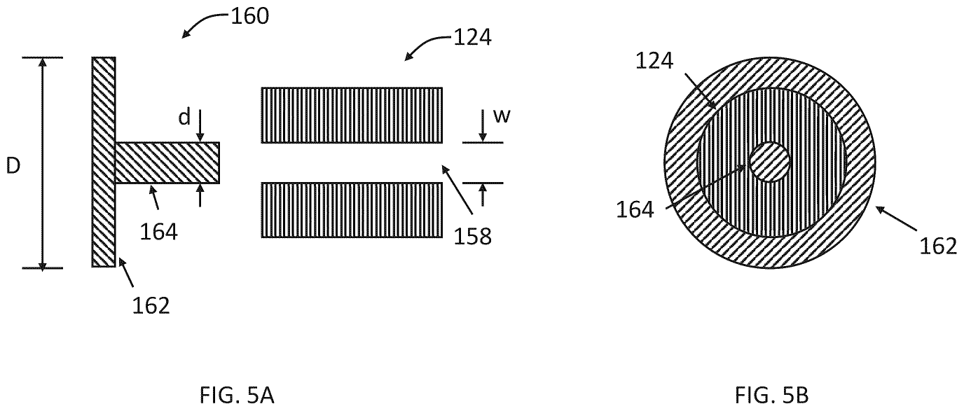

Referring to FIG. 5A, an end cap 160 is viewed in cross section, along with a pin 124, 126. The end cap 160 may include a disk 162 and a stud 164. The disk 162 has a diameter D. The stud 164 has a diameter d that is approximately equal to the inner diameter w of the pin 124, which the diameter of the hollow center 158 of the pin 124. The stud 164 secures the end cap 160 to the pin 124 when inserted into the hollow center 158 of the pin 124. Thus, at least one end of at least one pin of the left pin 124 and/or the right pin 126 may include a hollow center configured to mate with the respective end cap 160. In another aspect, an end cap 160 may fit securely over the outer diameter of the pin 124 with or without the inclusion of a stud 164. An end cap 160 may be removable from the respective pin 124, 126.

As used herein, the term “configured to” indicates that when a claimed apparatus or part of an apparatus has been manufactured, that element that is configured to do something will do that something when used by a user.

As used herein, the term “essentially” indicates that within tolerances understood by those of ordinary skill in the art and not necessarily with infinite precision.

Diameter is to be understood as perimeter or circumference when the feature being discussed is not circular except when explicitly noted otherwise.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A hanger for floor mats, the hanger comprising:
a frame, the frame comprising:
a front member comprising:
a front wall having an essentially flat front surface that extends farther horizontally than vertically;
a left front hole through the front wall; and
a right front hole through the front wall disposed essentially symmetrically in the horizontal direction and the vertical direction with the left front hole;
a back member comprising:
a back wall having an essentially flat back surface that extends horizontally and vertically to match the front wall, the back wall being essentially parallel to the front wall;
a left back hole through the back wall aligned in the front-back direction with the left front hole; and
a right back hole through the back wall aligned in the front-back direction with the right front hole;
at least a left crosspiece and a right crosspiece, each crosspiece fixed to both a top surface of the front member and a top surface of the back member; and
a left pin inserted through the left front hole and the left back hole and;
a right pin inserted through the right front hole and the right back hole;
a middle member comprising:
a right middle hole aligned with the right front hole and the right back hole and receiving the right pin and rotatable around the right pin in a plane essentially perpendicular to the right pin;
an upward opening aligned with the left front hole and the left back hole and configured to snap fit over the left pin;
a protrusion from a right end of the middle member that limits rotation of the middle member around the right pin; and
a vertical hole running through the middle member from top to bottom; and
a hook/handle member comprising:
a rod-like portion rotatably disposed through the vertical hole;
a hook opening downward; and
a handle,
wherein the middle member and the hook/handle member are configured to rotate as a unit down into the frame.

2. The hanger of claim 1, wherein:
the left pin and the right pin are configured to support at least one floor mat, and
a force greater than a force of the at least one floor mat on the snap fit is required to open the snap fit.

3. The hanger of claim 1, wherein:
the left pin and the right pin each include a front end cap and a back end cap to prevent the respective pins from moving relative to the frame, and
at least one of end cap for each respective pin is removable from the respective pin.

4. The hanger of claim 1, wherein the left front hole, the left back hole, the right front hole, the right back hole, the left pin, and the right pin are each circular in cross section.

5. The hanger of claim 4, wherein:
an inner diameter of the left front hole, an inner diameter of the left back hole, and the outer diameter of the left pin are essentially equal, and
an inner diameter of the right front hole, an inner diameter of the right back hole, an inner diameter of the right middle hole, and the outer diameter of the right pin are essentially equal.

6. The hanger of claim 1, wherein:
the left crosspiece is disposed above the left pin, and
the right crosspiece is disposed above the right pin.

7. The hanger of claim 1, the hanger further comprising at least one of metal or plastic.

8. The hanger of claim 1, wherein the frame further comprises a single piece.

9. The hanger of claim 1, wherein the rod-like portion is rotatably secured in the vertical hole by at least one of a snap fit, a cotter pin, a C-clip, an E-clip.

10. The hanger of claim 9, wherein:
the rod-like portion comprises a conically-shaped tip, and
the vertical hole comprises a bottom section that includes a slot that allows the bottom section to broaden temporarily while the conically-shaped tip passes through, forming a snap fit.

11. The hanger of claim 1, further comprising a three-sided cover suspended by the frame.

12. The hanger of claim 11, wherein:
the three sided cover hangs from at least one of the left crosspiece or the right crosspiece, and caps secure the cover to the rest of the hanger.

13. The hanger of claim 1, wherein the hook opens downward at an angle between 30° and 60°, inclusively, with the horizontal direction.

14. The hanger of claim 13, wherein the hook opens downward at an angle of essentially 45° with the horizontal direction.

15. The hanger of claim 1, wherein the frame further comprises a space between a back side of the front wall and a front side of the back wall sufficient for the middle member and at least a portion of the hook/handle member to rotate about the right pin and through the space.

16. The hanger of claim 1, wherein at least one end of at least one pin of the left pin or the right pin comprises a hollow center configured to mate with the respective end cap.
